(19) United States
(12) Patent Application Publication
(10) Pub. No.: US 2006/0168415 A1
(43) Pub. Date: Jul. 27, 2006

(54) Storage system, controlling method thereof, and virtualizing apparatus

(76) Inventors: Kenji Ishii, Ninomiya (JP); Akira Murotani, Odawara (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/101,511

(22) Filed: Apr. 8, 2005

(30) Foreign Application Priority Data
Jan. 25, 2005 (JP) 2005-017210

(51) Int. Cl. G06F 12/16

(52) U.S. Cl. 711/165

(57) ABSTRACT

A storage system, a controlling method thereof, and a virtual device that can secure enhanced reliability. A virtualizing apparatus for virtualizing storage areas provided by a storage apparatus to a host system consolidates the management of a data input/output limitation that is set for each storage area or for each piece of data and when data stored in one storage area is migrated to an other storage area, the virtualizing apparatus sets the input/output limitation setting of the storage area or data, to which the data is migrated, to that of the storage area or data from which the data is migrated.

### CROSS-REFERENCES TO RELATED APPLICATIONS

This application relates to and claims priority from Japanese Patent Application No. 2005-017210, filed on Jan. 25, 2005, the entire disclosure of which is incorporated herein by reference.

### BACKGROUND OF THE INVENTION

The present invention relates to a storage system, a controlling method thereof, and a virtualizing apparatus. More particularly, this invention relates to a technology applicable to, for example, a storage system that can retain archive data for a long period of time.

Lately the concept of Data Lifecycle Management (DLCM) has been proposed in the field of storage systems. Systems including DLCM are disclosed in, for example, Japanese Patent Laid-Open (Kokai) Publication No. 2003-345522, Japanese Patent Laid-Open (Kokai) Publication No. 2001-337790, Japanese Patent Laid-Open (Kokai) Publication No. 2001-67187, Japanese Patent Laid-Open (Kokai) Publication No. 2001-249853, and Japanese Patent Laid-Open (Kokai) Publication No. 2004-70403. The concept is to retain and manage data efficiently by focusing attention on the fact that the value of data changes over time.

For example, storing data of diminished value in expensive “1^{st} tier” storage devices is a waste of storage resources. Accordingly, inexpensive “2^{nd} tier” storage devices that are inferior to the 1^{st} tier in reliability, responsiveness, and durability as storage devices are utilized to archive information of diminished value.

Data to be archived can include data concerning which laws, office regulations or the like require retention for a certain period of time. The retention period varies depending on the type of data, and some data must be retained for several years to several decades (or even longer in some cases).

### SUMMARY OF THE INVENTION

If the legally required retention period for the archived data is long, a new problem arises; we have to consider the relationship between that and the life of the relevant storage system. Since high response performance is not generally required for a storage device used as an archive, an inexpensive disk drive with an estimated life of two to three years is used as a storage device. Accordingly, if laws, office regulations or the like require the retention of data for a certain period of time, there is a possibility that some unexpected event might take place and the storage device that stores the data would have to be replaced during the data retention period.

Therefore, it is the first object of this invention to provide a storage system that can retain data by migrating it between storage apparatuses so that the data can be supplied at any time during the retention period upon the request of a host system, even if the retention period required for the data is longer than the life of the storage apparatus.

Concerning such archive data, it is necessary to make a logical area in which the data is recorded (hereinafter referred to as “logical volume”) have a “read only” attribute in order to prevent falsification of the data. Therefore, the logical volume is set to a WORM (Write Once Read Many) setting to allow readout only.

However, if any situation occurs where data must be migrated due to any failure of the storage apparatus in part or in whole or due to the life-span of the storage apparatus as stated above, it is necessary to pass on the WORM setting together with the data to another storage apparatus (to which the data is migrated). This is to prevent falsification of the data at the other storage apparatus. It is also necessary to maintain the WORM attribute (whether or not the WORM setting is made, and its retention period) of the logical volume in which the data is stored.

Accordingly, it is the second object of this invention to pass on the attribute of the data in one storage area and the attribute of the storage area to the other storage area, even when a situation arises where the migration of the data between the storage apparatuses is required. The data attribute used herein means, for example, the data retention period and whether or not modification of the data is allowed. The attribute of the storage area includes information such as permission or no permission for writing to the relevant storage area, and performance conditions.

With a conventional storage system, the WORM attribute of each logical volume is set manually. Therefore, we cannot rule out the possibility that due to any setting error or malicious intent on the part of an operator, the WORM setting of the logical volume from which the relevant data is migrated might not be properly passed on to the logical volume to which the data is migrated, and thereby the WORM attribute might not be maintained. If such a situation occurs, there is the problem of, by overwriting or any other reason, falsification or loss of the data, which is guarded against by the WORM setting of the logical volume.

Moreover, regarding a storage system structured in a manner where storage apparatuses are directly connected to a host system, if data in one storage apparatus is migrated to another storage apparatus in order to replace the entire storage apparatus storing the logical volume having the WORM setting, or any storage device of the storage apparatus, a problem arises in that the attribute (such as a port number) of the logical volume as recognized by the host system may change as a result of the replacement, so that it becomes difficult to identify the location of the data by using an application that operates on the host system. Such a state of no access to the target data is equivalent to a state of data loss.

Consequently, it is the third object of this invention to enhance the reliability of the storage system by preventing the falsification or loss of the data that should be protected by the WORM setting, and to further enhance the reliability of the storage system by preventing failures caused by any change of the attribute of the logical volume as recognized by the host system as a result of the replacement of the storage apparatus or the storage device.

In order to achieve the above-described objects, the present invention provides a storage system comprising: one or more storage apparatuses, each having one or more storage areas; and a virtualizing apparatus for virtualizing each storage area for a host system; wherein the virtualizing apparatus consolidates the management of a data input/output limitation that is set for each storage area or for each piece of data stored in the storage area; wherein when the data stored in one storage area is migrated to another storage area, the virtualizing apparatus sets the input/output limitation setting of the storage area or data, to which the data is migrated, to that of the storage area or data from which the data is migrated.

This invention also provides a method for controlling a storage system that has one or more storage apparatuses, each having one or more storage areas, the method comprising: a first step of providing a virtualizing apparatus for virtualizing the respective storage areas for a host system and causing the virtualizing apparatus to consolidate the management of a data input/output limitation that is set for each storage area or for each piece of data stored in the storage area; and a second step of setting the input/output limitation setting of the storage area or data, to which the data is migrated, to that of the storage area or data, from which the data is migrated, when the data stored in one storage area is migrated to another storage area.

Moreover, this invention provides a virtualizing apparatus for virtualizing, for a host system, each storage area in one or more storage apparatuses, each having one or more storage areas, wherein the virtualizing apparatus comprises an input/output limitation controller for consolidating the management of a data input/output limitation that is set for each storage area or for each piece of data stored in the storage area; wherein when the data stored in one storage area is migrated to another storage area, the input/output information controller sets the input/output limitation setting of the storage area or data, to which the data is migrated, to that of the storage area or data from which the data is migrated.

Furthermore, this invention provides a storage system comprising: one or more storage apparatuses, each having one or more storage areas; and a virtualizing apparatus for virtualizing the respective storage areas for a host system and providing them as virtual storage areas; wherein the virtualizing apparatus consolidates the management of an input/output limitation setting, including a data retention period, for the virtual storage areas, by each storage area that constitutes the virtual storage area; and when the data stored in one storage area is migrated to another storage area, the virtualizing apparatus manages the input/output limitation of the storage area from which the data is migrated, as the setting of the input/output limitation of the storage area to which the data is migrated.

This invention also provides a method for controlling a storage system that has one or more storage apparatuses, each having one or more storage areas, the method comprising: a first step of providing a virtualizing apparatus for virtualizing the respective storage areas for a host system, to provide them as virtual storage areas, and using the virtualizing apparatus to consolidate the management of an input/output limitation setting, including a data retention period, for the virtual storage areas, by each storage area that constitutes the virtual storage area; and a second step of managing the input/output limitation of the storage area from which the data is migrated, as the setting of the input/output limitation of the storage area, to which the data is migrated, when the data stored in one storage area is migrated to another storage area.

Moreover, this invention provides a virtualizing apparatus for virtualizing, for a host system, each storage area in one or more storage apparatuses, each having one or more storage areas, and thereby providing them as virtual storage areas, wherein the virtualizing apparatus comprises an input/output limitation controller for consolidating the management of an input/output limitation setting, including a data retention period, for the virtual storage areas, by each storage area that constitutes the virtual storage area; wherein when the data stored in one storage area is migrated to another storage area, the input/output information controller manages the input/output limitation of the storage area from which the data is migrated, as the setting of the input/output limitation of the storage area to which the data is migrated.

When data in one storage area is migrated to another storage area in order to, for example, replace the storage apparatus in whole or in part, or the storage device, this invention makes it possible to pass on the input/output limitation that is set for the storage area from which the data is migrated, to the storage area to which the data is migrated. Accordingly, it is possible to retain and migrate the data between the storage apparatuses, and to pass on the attribute of the data and the attribute of the storage area, which retains the data, to the other data or storage area at the time of the data migration. Moreover, it is possible to prevent the falsification or loss of the data that should be protected by the input/output limitation, and to prevent failures caused by any change of the attribute of the storage area as recognized by the host system, thereby enhancing the reliability of the storage system.

### BRIEF DESCRIPTION OF THE DRAWINGS

FIG. 1 is a block diagram showing the configuration of the storage system according to an embodiment of this invention.

FIG. 2 is a block diagram showing an example of the configuration of the storage device.

FIG. 3 is a conceptual diagram of an address translation table.

FIG. 4 is a conceptual diagram of a migration information table.

FIG. 5 is a conceptual diagram that explains the process to generate a new address translation table at the time of data migration.

FIG. 6 is a conceptual diagram of a new address translation table.

FIG. 7 is a timing chart that explains the function of the storage system that maintains WORM attribute information.

FIG. 8 is a timing chart that explains the process flow when a read data request is made during data migration.

FIG. 9 is a timing chart that explains the process flow when a write data request is made during data migration.

FIG. 10 is a block diagram of the storage system according to another embodiment of this invention.

### DETAILED DESCRIPTION OF THE INVENTION

An embodiment of this invention is described below in detail with reference to the attached drawings.

### (1) Storage System Configuration according to this Embodiment

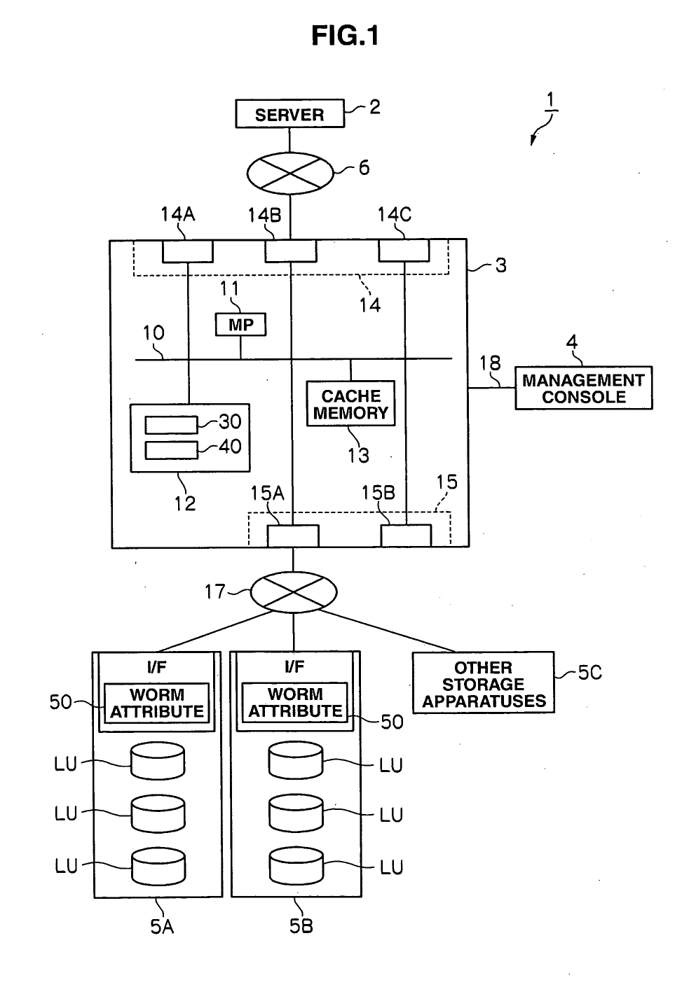

FIG. 1 shows the configuration of a storage system 1 according to this embodiment. This storage system 1 is composed of: a server 2; a virtualizing apparatus 3; a management console 4; and a plurality of storage apparatuses 5A to 5C.

The server 2, as a host system, is a computer device that comprises information processing resources such as a CPU (Central Processing Unit) and memory, and can be, for example, a personal computer, a workstation, or a mainframe. The server 2 includes: information input devices (not shown in the drawing) such as a keyboard, a switch, a pointing device, and/or a microphone; and information output devices (not shown in the drawing) such as a monitor display and/or speakers.

This server 2 is connected via a front-end network 6 composed of, for example, a SAN, a LAN, the Internet, public line(s), or private line(s), to the virtualizing apparatus 3. Communications between the server 2 and the virtualizing apparatus 3 via the front-end network 6 are conducted, for example, according to Fiber Channel Protocol (FCP) when the front-end network 6 is a SAN, or according to Transmission Control Protocol/Internet Protocol (TCP/IP) when the front-end network 6 is a LAN.

The virtualizing apparatus 3 executes processing to virtualize, for the server 2, logical volumes LU described later that are provided by the respective storage apparatuses 5A to 5C connected to the virtualizing apparatus 3. This virtualizing apparatus 3 comprises a microprocessor 11, a control memory 12, a cache memory 13, and first and second external interfaces 14 and 15, which are all mutually connected via a bus 10. The microprocessor 11 is composed of one or more Central Processing Units (CPUs) and executes various kinds of processing; for example, when the server 2 gives a data input/output request to the storage apparatus 5A, 5B or 5C, the microprocessor 11 sends the corresponding data input/output request to the relevant storage apparatus 5A, 5B or 5C in the storage device group 5. This virtualizing apparatus 3 is sometimes placed in a switching device connected to the communication line.

The control memory 12 is used as a work area of the microprocessor 11 and as memory for various kinds of control programs and data. For example, an address translation table 20 and a migration information table 21, which will be described later, are normally stored in this control memory 12. The cache memory 13 is used for temporary data storage during data transfer between the server 2 and the storage apparatuses 5A to 5C.

The first external interface 14 is the interface that performs protocol control during communication with the server 2. The first external interface 14 comprises a plurality of ports 14A to 14C and is connected via any one of the ports, for example, port 14B, to the front-end network 6. The respective ports 14A to 14C are given their network addresses such as a World Wide Name (WWN) or an Internet Protocol (IP) address to identify themselves on the front-end network 6.

The second external interface 15 is the interface that performs protocol control at during communication with the respective storage apparatuses 5A and 5B connected to the virtualizing apparatus 3. Like the first external interface 14, the second external interface 15 comprises a plurality of ports 15A and 15B and is connected via any one of the ports, for example, port 15A, to a back-end network 17 described later. The respective ports 15A and 15B of the second external interface 15 are also given the network addresses such as a WWN or IP address to identify themselves on the back-end network 17.

The management console 4 is composed of a computer such as a personal computer, a work station, or a portable information terminal, and is connected via a LAN 18 to the virtualizing apparatus 3. This management console 4 comprises: display units to display a GUI (Graphical User Interface) for performing various kinds of settings for the virtualizing apparatus 3, and other various information; input devices, such as a keyboard and a mouse, for an operator to input various kinds of operations and settings; and communication devices to communicate with the virtualizing apparatus 3 via the LAN 18. The management console 4 performs various kinds of processing based on various kinds of commands input via the input devices. For example, the management console 4 collects necessary information from the virtualizing apparatus 3 and displays the information on the display units, and sends various settings entered via the GUI displayed on the display units to the virtualizing apparatus 3.

The storage apparatuses 5A to 5C are respectively connected to the virtualizing apparatus 3 via the back-end network 17 composed of, for example, a SAN, a LAN, the Internet, or public or private lines. Communications between the virtualizing apparatus 3 and the storage apparatuses 5A to 5C via the back-end network 17 are conducted, for example, according to Fiber Channel Protocol (FCP) when the back-end network 17 is a SAN, or according to TCP/IP when the back-end network 17 is a LAN.

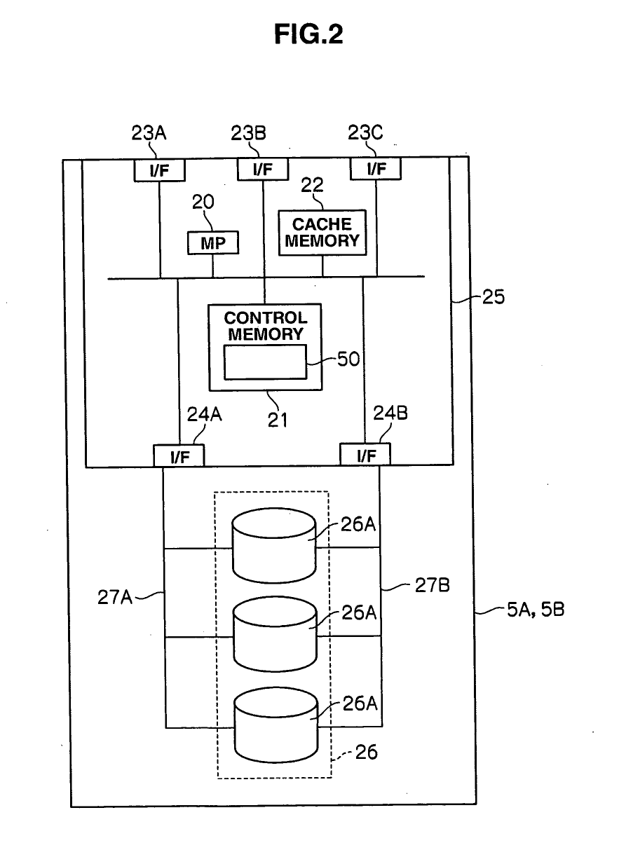

As shown in FIG. 2, each of the storage apparatuses 5A and 5B comprises: a control unit 25 composed of a microprocessor 20, a control memory 21, a cache memory 22, a plurality of first external interfaces 23A to 23C, and a plurality of second external interfaces 24A and 24B; and a storage device group 26 composed of a plurality of storage devices 26A.

The microprocessor 20 is composed of one or more CPUs and executes various kinds of processing according to control programs stored in the control memory 21. The control memory 21 is used as a work area of the microprocessor 20 and as memory for various kinds of control programs and data. The control memory 21 also stores a WORM attribute table described later. The cache memory 22 is used for temporary data storage during data transfer between the virtualizing apparatus 3 and the storage device group 26.

The first external interfaces 23A to 23C are the interfaces that perform protocol control during communication with the virtualizing apparatus 3. The first external interfaces 23A to 23C have their own ports, and any one of the first external interface 23A to 23C is connected via its port to the back-end network 17.

The second internal interfaces 24A and 24B are the interfaces that perform protocol control during communication with the storage devices 26A. The second internal interfaces 24A and 24B have their own ports and are respectively connected via their ports to the respective storage devices 26A of the storage device group 26.

Each storage device 26A is composed of an expensive disk device such as a SCSI (Small Computer System Interface) disk, or an inexpensive disk device such as a SATA (Serial AT Attachment) disk or an optical disk. Each storage device 26A is connected via two control lines 27A and 27B to the control unit 25 in order to provide redundancy.

In the storage apparatuses 5A and 5B, each storage device 26A is operated by the control unit 25 in the RAID system. One or more logical volumes (hereinafter referred to as the “logical volumes”) LU (FIG. 1) are set on physical storage areas provided by one or more storage devices 26A. These logical volumes LU store data. Each logical volume LU is given its own unique identifier (hereinafter referred to as “LUN (Logical Unit Number)”). In this embodiment described hereinafter, the storage apparatuses 5A to 5C manage the logical volumes LU corresponding to logical units.

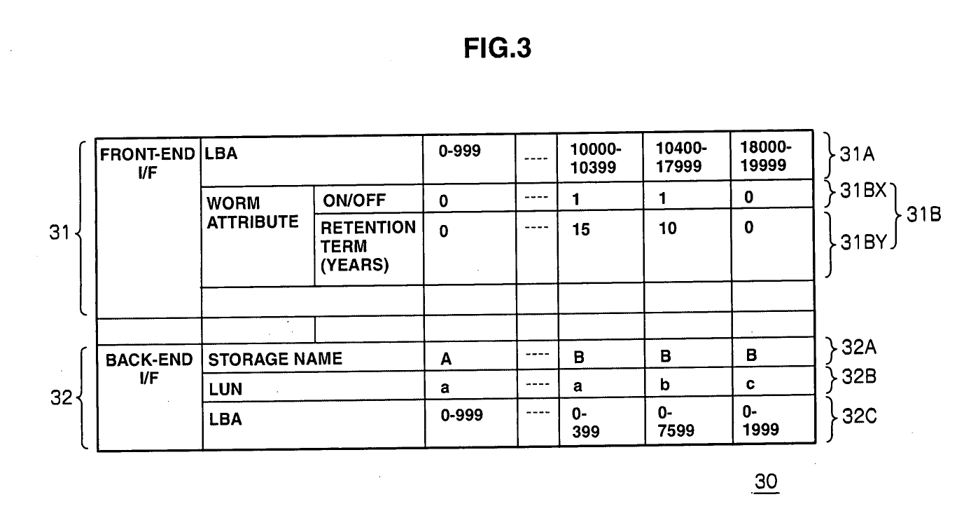

FIG. 3 shows an address translation table 30 stored in the control memory 12 of the virtualizing apparatus 3. FIG. 3 is an example of the table controlled by the virtualizing apparatus 3 with regard to one virtual logical volume LU provided by the virtualizing apparatus 3 to the server 2 (hereinafter referred to as the “virtual logical volume”). The virtualizing apparatus 3 may either describe the address translation table 30 for each virtual logical volume LU provided to the server 2, or describe and control a plurality of virtual logical volumes LU in the address translation table 30.

In the case of this storage system 1, the server 2 sends, to the virtualizing apparatus 3, a data input/output request that designates the LUN of the virtual logical volume (hereinafter referred to as the “virtual LUN”) that is the object of data input/output, and the length of the data to be input or output. Among serial numbers (hereinafter referred to as the “virtual LBAs (Logical Block Addresses)”) given respectively to all sectors in the storage areas provided by the respective storage apparatuses 5A to 5C in order to store real data of the virtual logical volumes, the input/output request includes the virtual LBA at the starting position of the data input/output. Using the address translation table 3, the virtualizing apparatus 3 translates the above-described virtual LUN and virtual LBA contained in the data input/output request, into the LUN of the logical volume LU, from or to which data should be read or written and the LBA at the starting position of the data input/output, and sends the post-translation data input/output request to the corresponding storage apparatus 5A, 5B or 5C. As described above, the address translation table 30 associates the address of each virtual logical volume LU (virtual LBA) recognized by the server 2, which is the host, with the identifier (LUN) and address (LBA) of the logical volume LU to or from which the data is actually read or written.

Referring to FIG. 3, “LBA” column 31A in “front-end I/F” column 31 indicates the virtual LBAs recognized by the server 2, which is the host. “Storage name” column 32A in “back-end I/F” column 32 indicates the storage name of the respective storage apparatuses 5A to 5C to which the virtual LBAs are actually assigned. “LUN” column 32B indicates the LUN of each logical volume LU provided by the storage apparatus 5A, 5B or 5C. “LBA” column 32C indicates the beginning LBA and the last LBA of the corresponding logical volume LU.

Accordingly, in the example of FIG. 3, you can see that the virtual LBAs “0-999” designated by the server 2 belong to the logical volume LU of the LUN “a” provided by the storage apparatus 5A with the storage name “A,” and the virtual LBAs “0-999” correspond to the LBAs “0-999” of the logical volume LU with the LUN “a” of the storage apparatus 5A with the storage name “A.” Also, you can see that the virtual LBAs “1000-10399” designated by the server 2 belong to the logical volume LU of the LUN “a” provided by the storage device 5B with the storage name “B,” and the virtual LBAs correspond to the LBAs “0-399” of the logical volume LU with the LUN “a” of the storage device 5B with the storage name “B.”

As described above, it is possible to virtualize the logical volume LU provided by the respective storage apparatuses 5A to 5C to the server 2 by translating the virtual LUN and the virtual LBA contained in the data input/output request from the server 2 into the LUN of the logical volume LU to or from which data should be actually input or output, and the LBA at the starting position of the actual data input/output, and sending them to the corresponding storage apparatus 5A, 5B, or 5C. Consequently, even if data stored in one logical volume LU is migrated to another logical volume LU in order to replace a storage device 26A of the storage apparatus 5A, 5B or 5C or the entire storage apparatus 5A, 5B or 5C due to, for example, their life-span or any failure, it is possible to input or output the data desired by the server 2 by designating the same virtual LUN or virtual LBA as before the replacement without making the server 2, which is the host, recognize the migration of the data.

The details of the address translation table 30 are registered by the operator, using the management console 4, and are changed when the number of the storage apparatuses 5A to 5C connected to the virtualizing apparatus 3 is increased or decreased, or when part of the storage device 26A of the storage apparatus 5A, 5B or 5C or the entire storage apparatus 5A, 5B or 5C is replaced due to their life-span or any failure as described later.

Actions of data input to or output from the storage apparatuses 5A to 5C in the storage system 1 are described below.

The server 2 sends, when necessary, to the virtualizing apparatus 3, the data input/output request to the storage apparatus 5A, 5B or 5C, that designates the virtual LUN of the virtual logical volume LU which is the target, the virtual LBA at the starting position of the data, and the data length. At this moment, if the data input/output request is a write request, the server 2 sends the write data together with the write request to the virtualizing apparatus 3. Then, the write data is temporarily stored in the cache memory 13 of the virtualizing apparatus 3.

Once receiving the data input/output request from the server 2, the virtualizing apparatus 3 uses the address translation table 30 to translate the virtual LUN and the virtual LBA, which are contained in the data input/output request as the address to or from which the data is input or output, into the LUN of the logical volume to or from which the data is actually input or output, and the LBA at the input/output starting position; and the virtualizing apparatus 3 then sends the post-translation data input/output request to the corresponding storage device. If the data input/output request from the server 2 is a write request, the virtualizing apparatus 3 sends the write data, which is temporarily stored in the cache memory 13, to the corresponding storage apparatus 5A, 5B or 5C.

When the storage apparatus 5A, 5B or 5C receives the data input/output request from the virtualizing apparatus 3 and if the data input/output request is a write request, the storage apparatus 5A, 5B or 5C writes the data, which has been received with the write request, in blocks from the starting position of the designated LBA in the designated logical volume LU.

If the data input/output request from the virtualizing apparatus 3 is a read request, the storage apparatus 5A, 5B or 5C starts reading the corresponding data in blocks from the starting position of the designated LBA in the designated logical volume LU and stores the data in the cache memory 22 sequentially. The storage apparatus 5A, 5B or 5C then reads the data in blocks stored in the cache memory 22 and transfers it to the virtualizing apparatus 3. This data transfer is conducted in blocks or files when the back-end network 17 is, for example, a SAN, or in files when the back-end network 17 is, for example, a LAN. Subsequently, this data is transferred via the virtualizing apparatus 3 to the server 2.

### (2) WORM-Attribute-Information-Maintaining Function of Storage System

The WORM-attribute-information-maintaining function that is incorporated into the storage system 1 is described below. This storage system 1 is characterized in that the WORM attribute (whether or not the WORM setting is made, and its retention period) can be set for each logical volume provided by the storage apparatuses 5A to 5C, to or from which data is actually input or output, and the virtualizing apparatus 3 consolidates the management of the WORM attribute for each logical volume.

As shown in FIG. 3, the “front-end I/F” column 31 of the above-described address translation table 30 retained by the virtualizing apparatus 3 includes “WORM attribute” column 31B for description of the WORM attribute of each logical volume provided by the storage apparatuses 5A, 5B or 5C.

This “WORM attribute” column 31B consists of an “ON/OFF” column 31BX and a “retention term” column 31BY. If the relevant logical volume has the WORM setting (the setting that allows read only and no overwriting of data), the relevant “ON/OFF” column 31BX shows a “1”; if the relevant logical volume does not have the WORM setting, the relevant “ON/OFF” column 31BX shows a “0.” Moreover, if the logical volume has the WORM setting, the “retention term” column 31BY indicates the data retention term for the data stored in the logical volume LU. FIG. 3 shows the retention period in years, but it is possible to set the retention period in months, weeks, days, or hours.

When the server 2 gives a data write request to overwrite data, as an data input/output request to the storage apparatus 5A, 5B or 5C, the virtualizing apparatus 3 refers to the address translation table 30 and determines whether or not the target logical volume LU has the WORM setting (i.e., whether the “ON/OFF” column 31BX in the relevant “WORM attribute” column 31B is showing a “1” or a “0”). If the logical volume does not have the WORM setting, the virtualizing apparatus 3 then accepts the data write request. On the other hand, if the logical volume has the WORM setting, the virtualizing apparatus 3 notifies the server 2 of the rejection of the data write request.

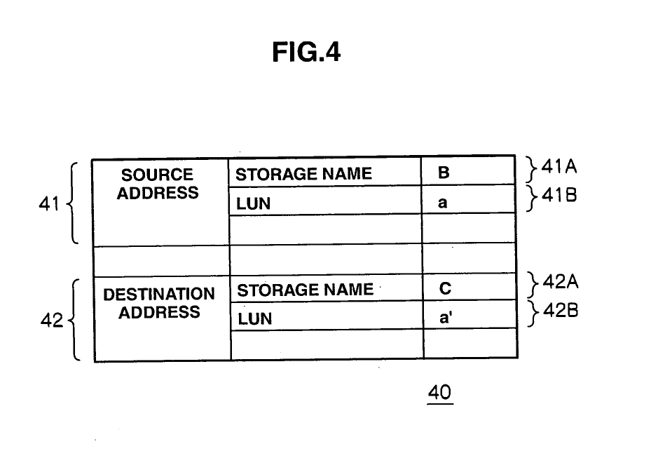

Moreover, the virtualizing apparatus 3 has a migration information table 40, as shown in FIG. 4, in the control memory 12 (FIG. 1). When data stored in one logical volume LU is migrated to another logical volume LU, the migration information table 40 associates the position of a source logical volume LU, from which the data is migrated (hereinafter referred to as the “source logical volume”), with a destination logical volume LU, to which the data is migrated (hereinafter referred to as the “destination logical volume”).

When data in one logical volume LU is migrated to another logical volume LU in order to replace, for example, the storage device 26 of the storage apparatus 5A, 5B or 5C, or the entire storage apparatus 5A, 5B or 5C, the operator makes the management console 4 (FIG. 1) give the virtualizing apparatus 3 the storage name of the storage apparatus 5A, 5B or 5C that has the source logical volume LU, and the LUN of that source logical volume LU, as well as the storage name of the storage apparatus 5A, 5B or 5C that has the destination logical volume LU, and the LUN of that destination logical volume LU. In this embodiment, the name of the storage apparatus 5A, 5B or 5C is stored, but any name may be used as long as the name can uniquely identify the storage apparatus 5A, 5B or 5C.

As a result, the storage name of the of the storage apparatus 5A, 5B or 5C that has the source logical volume LU, and the LUN of that source logical volume LU are respectively indicated in a “storage name” column 41A and an “LUN” column 41B in a “source address” column 41 of the migration information table 40, while the storage name of the storage apparatus 5A, 5B or 5C that has the destination logical volume LU, and the LUN of that destination logical volume LU are respectively indicated in a “storage name” column 42A and an “LUN” column 42B in a “destination address” column 42 of the migration information table 40.

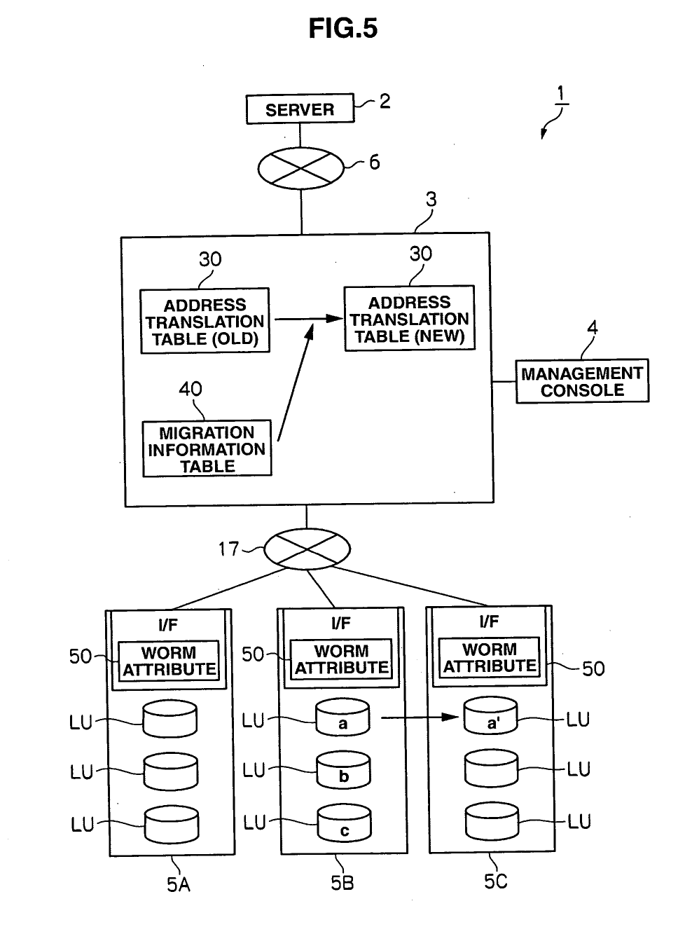

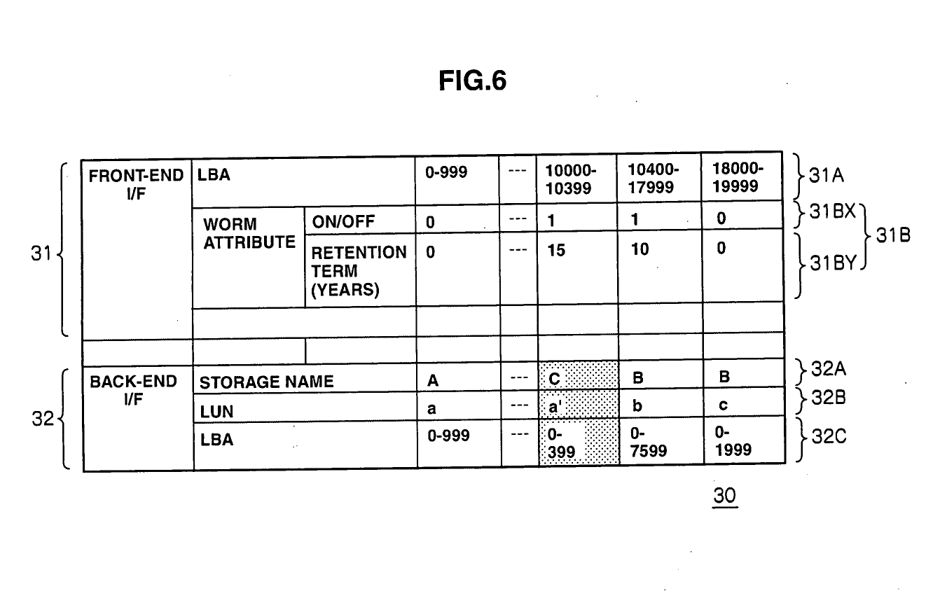

As shown in FIG. 5, once the migration of data is started from the source logical volume LU to the destination logical volume LU, which are both registered in the migration information table 40, the virtualizing apparatus 3 generates a new address translation table 30, as shown in FIG. 6, based on the migration information table 40 and the address translation table 30 (FIG. 3) by changing the respective contents of the “storage name” column 32A and the “LUN” column 32B of the source logical volume LU in the “back-end I/F” column 31 of the address translation table 30 to the contents of the “storage name” column 42A and the “LUN” column 42B of the destination logical volume LU in the migration information table 40; after the completion of the data migration, the virtualizing apparatus 3 then switches the original address translation table 30 to the new address translation table 30 and performs the processing to virtualize the logical volumes provided by the storage apparatus 5A, 5B or 5C, using the new address translation table 30.

In this case, this new address translation table 30 is generated by changing only the “storage name” and the “LUN” of the “back-end I/F” without changing the content of the “WORM attribute information” column 31B as described above. Accordingly, the WORM attribute that is set for the source logical volume which had stored the relevant data is passed on accurately to the destination logical volume LU. Therefore, when data stored in one logical volume is migrated to another logical volume, it is possible to prevent, with certainty, any setting error or any malicious alteration of the WORM attribute of the relevant data, and to prevent any accident such as the falsification or loss of the data that should be protected by the WORM setting.

This storage system 1 is configured in a manner such that each storage apparatus 5A, 5B or 5C stores and retains, in the control memory 21 (FIG. 2), a WORM attribute information table 50 generated by extracting only the WORM attribute information of each logical volume of the storage apparatus 5A, 5B or 5C, and the virtualizing apparatus 3 gives the WORM attribute information table 50 to the relevant storage apparatus 5A, 5B or 5C at specified time. As each storage apparatus 5A, 5B or 5C imposes an input/output limitation on its logical volumes LU according to the WORM attribute information table 50, it is possible to prevent any unauthorized connection to the back-end network 17 that cannot be controlled by the virtualizing apparatus 3, and to prevent any unauthorized update of the data stored in the logical volume where an initiator connected to the back-end network 17 has made the WORM setting by error. Therefore, also when replacing the virtualizing apparatus 3, it is possible to maintain the WORM attribute information accurately based on the WORM attribute information table 50 stored and retained by each storage apparatus 5A, 5B or 5C.

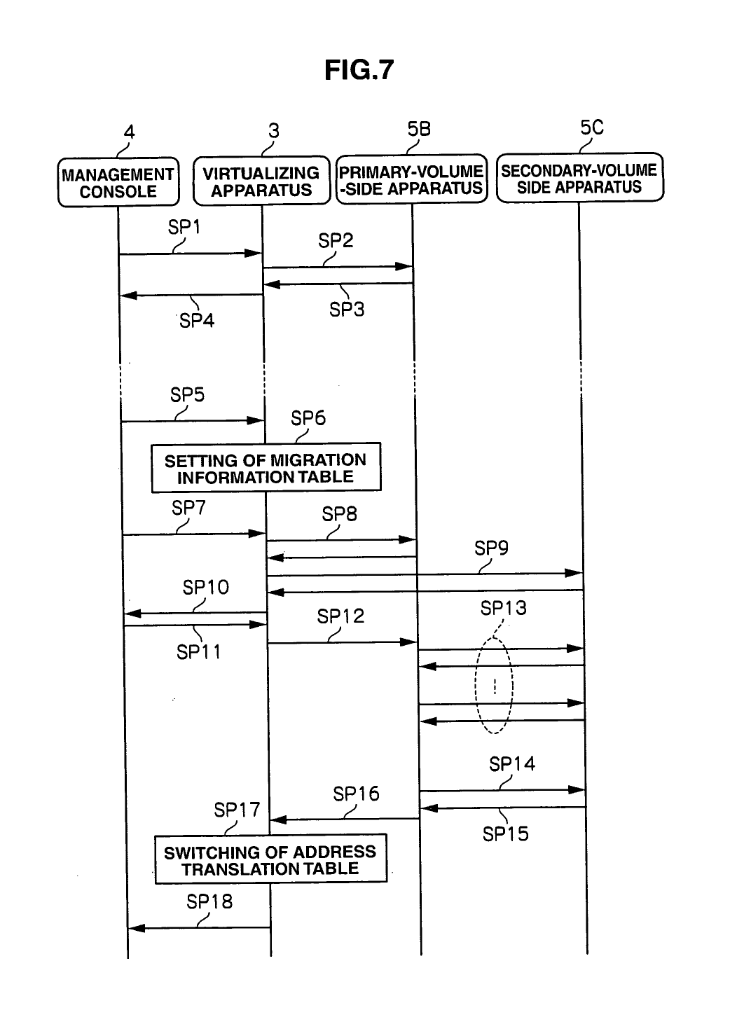

FIG. 7 is a timing chart that explains the process flow relating to the WORM-attribute-information-maintaining function. First, an initial setting of the WORM attribute for each logical volume provided by the storage apparatuses 5A, 5B and 5C is explained as follows. The initial setting of the WORM attribute for the logical volume LU is made by operating the management console 4 to designate a parameter value (0 or 1) to be stored in the “ON/OFF” column 31BX in the “WORM attribute” column 31B of the address translation table 30 stored in the control memory 12 of the virtualizing apparatus 3 (SP1). However, the setting content is not effective at this moment.

Subsequently, based on the above tentative setting, the virtualizing apparatus 3 sends a guard command to make the WORM setting for the relevant logical volume, to the relevant storage apparatus 5A, 5B or 5C (SP2). The storage apparatus 5A, 5B or 5C makes the WORM setting for the logical volume based on the guard command. After the WORM setting, the storage apparatus 5A, 5B or 5C notifies the virtualizing apparatus 3 to that effect (SP3). At this stage, the virtualizing apparatus 3 finalizes the parameter stored in the “ON/OFF” column 31BX in the “WORM attribute” column 31B of the address translation table 30. The virtualizing apparatus 3 then notifies the management console 4 of the finalization of the parameter (SP4).

Next, an explanation is given below about a case where the storage device 26 of the storage apparatus 5A, 5B or 5C connected to the virtualizing apparatus 3 is replaced. In the following description, the data having the WORM setting that is stored in the logical volume LU with the LUN (a) of the storage apparatus 5B connected to the virtualizing apparatus 3 is migrated together with the WORM attribute information to the logical volume with the LUN (a′) of the storage apparatus 5C.

The operator first inputs, to the management console 4, the setting of the storage name of the storage apparatus 5B, in which the data to be migrated exists, and the LUN (a) of the logical volume. Then, in the same manner, the operator inputs, to the management console 4, the storage name of the storage apparatus 5C and the LUN (a′) of the logical volume to which the data should be migrated. The management console 4 notifies the virtualizing apparatus 3 of this entered setting information (SP5). Based on this notification, the virtualizing apparatus 3 generates the actual migration information table 40 by sequentially storing the necessary information in the corresponding columns of the migration information table 40 (SP6). At this moment, the destination logical volume LU is reserved and locked, and thereby cannot be used for any other purpose until the completion of the data migration.

Subsequently, when the operator inputs the command to start the data migration to the management console 4, a command in response to the above command (“hereinafter referred to as the “migration start command”) is given to the virtualizing apparatus 3 (SP7). At this moment, the virtualizing apparatus 3 generates a new address translation table (hereinafter referred to as the “new address translation table”) as described above based on the then address translation table 30 (hereinafter referred to as the “old address translation table”) and the migration information table 40. Accordingly, the WORM attribute information about the data is maintained in this new address translation table 30. However, the new address translation table 30 is retained in a suspended state at this point.

Receiving the migration start command from the management console 4, the virtualizing apparatus 3 controls the relevant storage apparatuses 5B and 5C and executes the data migration by utilizing a remote copy function of the storage apparatuses 5B and 5C. The remote copy function is to copy the content of the logical volume LU that constitutes a unit to be processed (hereinafter referred to as the “primary volume” as appropriate) to another logical volume LU (hereinafter referred to as the “secondary volume” as appropriate) between the storage apparatuses 5A, 5B and 5C. In the remote copying, a pair setting is first conducted to associate the primary volume with the secondary volume, and then the data migration from the primary volume to the secondary volume is started. The remote copy function is described in detail in Japanese Patent Laid-Open (Kokai) Publication No. 2002-189570.

For the data migration from the primary volume to the secondary volume by the above-described remote copy function, the virtualizing apparatus 3 first refers to the migration information table 40 and sends a command to the storage apparatus 5B which provides the source logical volume LU (the logical volume LU with the LUN “a”), thereby setting the source logical volume LU as the primary volume for the remote copying (SP8). At the same time, the virtualizing apparatus 3 sends a command to the storage apparatus 5C which provides the destination logical volume LU (the logical volume LU with the LUN “a′”), thereby setting the destination logical volume LU as the secondary volume for the remote copying (SP9). After setting the source logical volume LU and the destination logical volume LU as a pair of the primary volume and the secondary volume for the remote copying, the virtualizing apparatus 3 notifies the management console 4 to that effect (SP10).

When the management console 4 receives the above notification, it sends a command to start the remote copying to the virtualizing apparatus 3 (SP11). When the virtualizing apparatus 3 receives this command, it sends a start command to the primary-volume-side storage apparatus 5B (SP12). In response to this start command, the data migration from the primary-volume-side storage apparatus 5B to the secondary-volume-side storage apparatus 5C is executed (SP13).

When the data migration is completed, the primary-volume-side storage apparatus 5B notifies the secondary-volume-side storage apparatus 5C that the migrated data should be guarded by the WORM (SP14). In accordance with the notification, at the secondary-volume-side storage apparatus 5C, the WORM attribute of the secondary volume is registered with the WORM attribute information table 50 (i.e., the WORM setting of the secondary volume is made in the WORM attribute information table 50), and then the secondary-volume-side storage apparatus 5C notifies the primary-volume-side storage apparatus 5B to that effect (SP15).

If the primary volume is being continuously updated while the normal remote copying is taking place, the storage apparatuses 5A to 5C monitor the updated content of the primary volume, from which the data is being migrated, and the data migration is performed until the content of the primary volume and that of the secondary volume become completely the same. However, if the primary volume has the WORM setting, no data update is conducted. Accordingly, it is possible to cancel the pair setting when the data migration from the primary volume to the secondary volume is finished.

When the primary-volume-side storage apparatus 5B receives the above notification, and after the pair setting of the primary volume and the secondary volume is cancelled, the primary-volume-side storage apparatus 5B notifies the virtualizing apparatus 3 that the WORM setting of the secondary volume has been made (SP16). Receiving the notification that the WORM setting of the secondary volume has been made, the virtualizing apparatus 3 switches the address translation table 30 to the new address translation table 30 and thereby activates the new address translation table 30 (SP17), and then notifies the management console 4 that the data migration has been completed (SP18).

In the remote copy processing in general, the secondary volume is in a state where the data from the primary volume is being copied during the remote copying, and no update from the host is made to the secondary volume. Once the copying is completed and the pair setting is cancelled, the secondary volume becomes accessible, for example, to an update from the host. In this embodiment, only after the data migration is completed, is an update guard setting of the WORM attribute information table 50 of the secondary volume made, and then the pair setting cancelled.

This is because of the following reasons: if the update guard is applied to the secondary volume before the data migration, it is impossible to write any data to the secondary volume, thereby making it impossible to migrate the data; and if the update guard is set after the cancellation of the pair setting, there is a possibility that any unauthorized update of the secondary volume might be made from the back-end network 17 after the cancellation of the pair setting and before the update guard setting. Accordingly, in this embodiment, it is possible to prevent the unauthorized access from the back-end network 17 to the secondary volume and to execute the remote copy processing. Moreover, if the setting can be made to determine, depending on the source apparatus from which the data is sent, whether or not to accept an update guard setting request during the pair setting, for example, by allowing only the primary-volume-side storage apparatus 5B to accept the update guard setting request, it is possible to avoid interference with the data migration due to an update guard setting request from any unauthorized source.

If during the data migration processing described above the synchronization of the primary volume with the secondary volume for the remote copying fails or if the WORM setting switching to the migrated data in the secondary-volume-side storage apparatus 5C fails, the virtualizing apparatus 3 notifies the management console 4 of the failure of the data migration. As a result, the data migration processing ends in an error and the switching of the address translation table 30 at the virtualizing apparatus 3 is not performed.

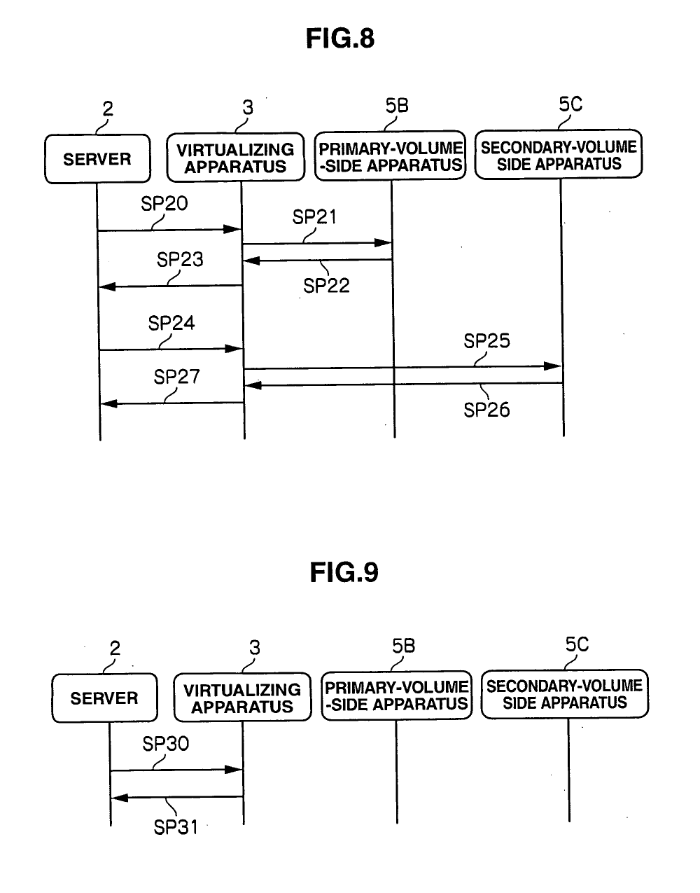

FIG. 8 is a timing chart that explains the process flow when the server 2 gives a data read request regarding the data that is being migrated during the data migration processing. In this case, when the server 2 gives the data read request to the virtualizing apparatus 3 (SP20), and if the address translation table 30 has not been switched to the new address table 30 yet, the virtualizing apparatus 3 translates, based on the old address translation table 30, the LUN of the target logical volume LU and the virtual LBA of the input/output starting position, which are contained in the data read request, to the LUN and LBA of the primary volume (the source logical volume LU) respectively, and then sends the LUN and LBA after translation to the storage apparatus 5B which has the primary volume (SP21), thereby causing the designated data to be read out from the primary volume (SP22) and the obtained data to be sent to the server 2 (SP23).

On the other hand, when the server 2 gives a data read request (SP24), and if the address translation table 30 has been switched to the new address translation table 30, the virtualizing apparatus 3 translates, based on the new address translation table 30, the LUN of the target logical volume LU and the virtual LBA of the input/output starting position, which are contained in the data read request, to the LUN and LBA of the secondary volume (the destination logical volume LU) respectively, and then sends the LUN and LBA after translation to the storage apparatus 5C which has the secondary volume (SP25), thereby causing the designated data to be read out from the secondary volume (SP26) and the obtained data to be sent to the server 2 (SP27).

FIG. 9 is a timing chart that explains the process flow when the server 2 gives a data write request regarding the data that is being migrated during the data migration processing. In this case, when the server 2 gives the data write request to the virtualizing apparatus 3 (SP30), the virtualizing apparatus 3 refers to the address translation table 30 and confirms that the “ON/OFF” column 31BX in the “WORM attribute” column 31B for the logical volume VU that stores the data indicates “1,” the virtualizing apparatus 3 then notifies the server 2 that the data write request is rejected.

Since in the storage system 1 the virtualizing apparatus 3 for virtualizing each logical volume LU provided by each storage apparatus 5A, 5B or 5C for the server 2 is located between the server 2 and the respective storage apparatuses 5A to 5C, even if data stored in one logical volume LU is migrated to another logical volume LU in order to replace the storage device 26A of the storage apparatus 5A, 5B or 5C, or the entire storage apparatus 5A, 5B or 5C, it is possible to input or output the data desired by the server 2 by designating the same logical volume LU as that before the replacement, without having the server 2, the host, recognize the data migration.

Moreover, the virtualizing apparatus 3 also consolidates the management of the WORM attribute of each logical volume LU provided by each storage apparatus 5A, 5B or 5C; when data stored in one logical volume LU is migrated to another logical volume LU, the virtualizing apparatus 3 uses the original address translation table 30 and the migration information table 40 to generate a new address translation table 30 so that the WORM attribute of the source logical volume LU can be passed on to the destination logical volume LU. Accordingly, it is possible to prevent, with certainty, any setting error or malicious alteration of the WORM attribute of the data and to prevent falsification or loss of data that should be protected by the WORM setting.

As described above, with the storage system 1 according to this embodiment, it is possible to enhance the reliability of the storage system by preventing any alteration or loss of data that should be protected by the WORM setting, and to further enhance reliability by preventing any failure caused by any change of the attribute of the logical volume as recognized by the host system before and after the replacement of the storage apparatus or the storage device.

### (3) Other Embodiments

Concerning the above-described embodiment, the case where the present invention is applied to the storage system 1 in which the WORM setting can be set for each logical volume LU is explained. However, this invention is not limited to that application, and may be applied extensively to a storage system in which the WORM setting can be made for each storage apparatus 5A, 5B or 5C (i.e., the entire storage area provided by one storage apparatus 5A, 5B or 5C constitutes a unit for the WORM setting), or to a storage system in which the WORM setting can be made for each storage area unit that is different from the logical volume LU.

The above embodiment describes the case where the WORM attribute of the source logical volume LU is passed on to the destination logical volume during data migration. However, not only the WORM attribute, but also, for example, the setting of other input/output limitations (such as a limitation to prohibit data readout, and other limitations) on the source logical volume LU can be passed on to the destination logical volume LU in the same manner.

Moreover, the above embodiment describes the case where in the virtualizing apparatus 3, the input/output limitation controller for consolidating the management of the WORM attribute set for each logical volume LU consists of the microprocessor 11 and the control memory 12. However, this invention is not limited to that configuration, and may be applied to various other configurations.

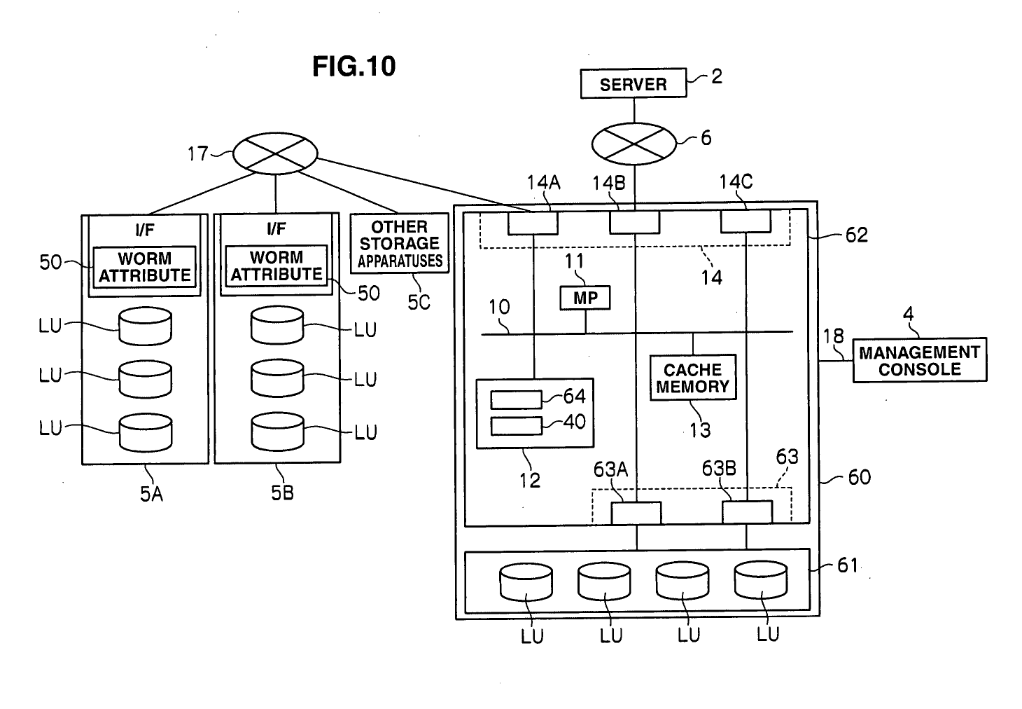

Furthermore, the above embodiment describes the case where the virtualizing apparatus 3 has no storage device. However, this invention is not limited to that configuration; as shown in FIG. 10 in which components corresponding to those of FIG. 1 are given the same reference numerals as those of FIG. 1, and a virtualizing apparatus 60 may have one or more storage devices 61. FIG. 10 shows a configuration example where a control unit 62 configured almost in the same manner as the virtualizing apparatus 3 of FIG. 1 is connected via the respective ports 63A and 63B of a disk interface 63 to the respective storage devices 61, and is also connected via any one of the ports of the first external interface 14, for example, the port 14A, to the back-end network 17. If the virtualizing apparatus 60 is configured in the above-described manner, it is necessary to register information about the logical volumes LU provided by the virtualizing apparatus 60, such as the LUN and the WORM attribute, with an address translation table 64 in the same manner as the logical volumes LU of the storage apparatuses 5A to 5C in order to, for example, virtualize the logical volumes LU provided by the virtualizing apparatus 60 to the server 2.

Also in the above-described embodiment, the virtualizing apparatus 3 consolidates the management of the WORM setting that is made for each logical volume LU; and when data stored in one logical volume LU is migrated to another logical volume, the WORM setting of the destination logical volume LU is set to that of the source logical volume LU. However, this invention is not limited to that configuration. For example, the virtualizing apparatus 3 may be configured so that the WORM setting can be made for each piece of data in the virtualizing apparatus 3; or the virtualizing apparatus 3 may be configured so that when data stored in one logical volume LU is migrated to another logical volume LU, the WORM setting of the post-migration data can be set to that of the pre-migration data.

Therefore, the present invention can be applied extensively to various forms of storage systems besides, for example, a storage system that retains archive data for a long period of time.

What is claimed is:

1. A storage system comprising:
one or more storage apparatuses, each having one or more storage areas; and
a virtualizing apparatus for virtualizing each storage area for a host system;
wherein the virtualizing apparatus consolidates the management of a data input/output limitation that is set for each storage area or for each piece of data stored in the storage area; and
wherein when the data stored in one storage area is migrated to another storage area, the virtualizing apparatus sets the input/output limitation setting of the storage area or data, to which the data is migrated, to that of the storage area or data from which the data is migrated.

2. The storage system according to claim 1, wherein the input/output limitation enables only readout of the data.

3. The storage system according to claim 2, wherein the input/output limitation includes a retention period for the data.

4. The storage system according to claim 1, wherein the virtualizing apparatus has an address translation table that associates virtual addresses of the storage areas recognized by the host system, real addresses of the respective storage areas, and the details of the input/output limitation setting of the storage areas with one another, and the virtualizing apparatus virtualizes the respective storage areas for the host system by translating an address of a data input/output request from the host system, using the address translation table; and
wherein when the data stored in one storage area is migrated to another storage area, the virtualizing apparatus sets the input/output limitation setting of the storage area, to which the data is migrated, to that of the storage area, from which the data is migrated, via generating a new address translation table by changing the address of one storage area in the address translation table to the address of the other storage area, and switching the address translation table to the new address translation table.

5. The storage system according to claim 4, comprising a management console for an operator to input the settings of one storage area and another storage area,
wherein the management console notifies the virtualizing apparatus of one storage area and the other storage area whose settings are inputted, and
the virtualizing apparatus generates, based on the notification from the management console, a migration information table that associates one storage area with the other storage area, and generates the new address translation table based on the generated migration information table and the original address translation table.

6. A method for controlling a storage system that has one or more storage apparatuses, each having one or more storage areas, the method comprising:
a first step of providing a virtualizing apparatus for virtualizing the respective storage areas for a host system and causing the virtualizing apparatus to consolidate the management of a data input/output limitation that is set for each storage area or for each piece of data stored in the storage area; and
a second step of setting the input/output limitation setting of the storage area or data, to which the data is migrated, to that of the storage area or data, from which the data is migrated, when the data stored in one storage area is migrated to another storage area.

7. The storage system controlling method according to claim 5, wherein the input/output limitation enables only readout of the data.

8. The storage system controlling method according to claim 7, wherein the input/output limitation includes a retention period for the data.

9. The storage system controlling method according to claim 6, wherein the virtualizing apparatus has an address translation table that associates virtual addresses of the storage areas recognized by the host system, real addresses of the respective storage areas, and the details of the input/output limitation setting of the storage areas with one another;
wherein in the first step, the virtualizing apparatus virtualizes the respective storage areas for the host system by translating an address of a data input/output request from the host system, using the address translation table; and
wherein in the second step, when the data stored in one storage area is migrated to another storage area, the input/output limitation setting of the storage area, to which the data is migrated, is set to that of the storage area, from which the data is migrated, via generating a new address translation table by changing the address of one storage area in the address translation table to the address of the other storage area, and switching the address translation table to the new address translation table.

10. The storage system controlling method according to claim 9, wherein the storage system comprises a management console for an operator to input the settings of one storage area and another storage area; and
wherein in the second step, the management console notifies the virtualizing apparatus of one storage area and the other storage area whose settings are inputted, and
the virtualizing apparatus generates, based on the notification from the management console, a migration information table that associates one storage area with the other storage area, and generates the new address translation table based on the generated migration information table and the original address translation table.

11. A virtualizing apparatus for virtualizing, for a host system, each storage area in one or more storage apparatuses, each having one or more storage areas,
wherein the virtualizing apparatus comprises an input/output limitation controller for consolidating the management of a data input/output limitation that is set for each storage area or for each piece of data stored in the storage area;
wherein when the data stored in one storage area is migrated to another storage area, the input/output limitation controller sets the input/output limitation setting of the storage area or data, to which the data is migrated, to that of the storage area or data from which the data is migrated.

12. The virtualizing apparatus according to claim 11, wherein the input/output limitation enables only readout of the data.

13. The virtualizing apparatus according to claim 12, wherein the input/output limitation includes a retention period for the data.

14. The virtualizing apparatus according to claim 11, wherein the input/output limitation controller comprises a memory that stores an address translation table that associates virtual addresses of the storage areas recognized by the host system, real addresses of the respective storage areas, and the details of the input/output limitation setting of the storage areas with one another; and
wherein the input/output limitation controller virtualizes the respective storage areas for the host system by translating an address of a data input/output request from the host system, using the address translation table; and when the data stored in one storage area is migrated to another storage area, the input/output limitation controller sets the input/output limitation setting of the storage area or data, to which the data is migrated, to that of the storage area or data, from which the data is migrated, via generating a new address translation table by changing the address of one storage area in the address translation table to the address of the other storage area, and switching the address translation table to the new address translation table.

15. The virtualizing apparatus according to claim 14, wherein the input/output limitation controller generates: a migration information table that associates one storage area with another storage area, having been notified by an external device, whose settings are inputted by an operator; and the new address translation table based on the generated migration information table and the original address translation table.

16. A storage system comprising:
one or more storage apparatuses, each having one ore more storage areas; and
a virtualizing apparatus for virtualizing the respective storage areas for a host system and providing them as virtual storage areas;
wherein the virtualizing apparatus consolidates the management of an input/output limitation setting, including a data retention period, for the virtual storage areas, by each storage area that constitutes the virtual storage area; and when the data stored in one storage area is migrated to another storage area, the virtualizing apparatus manages the input/output limitation of the storage area, from which the data is migrated, as the setting of the input/output limitation of the storage area to which the data is migrated.

17. A method for controlling a storage system that has one or more storage apparatuses, each having one or more storage areas, the method comprising:
a first step of providing a virtualizing apparatus for virtualizing the respective storage areas for a host system to provide them as virtual storage areas, and using the virtualizing apparatus to consolidate the management of an input/output limitation setting, including a data retention period, for the virtual storage areas by each storage area that constitutes the virtual storage area; and
a second step of managing the input/output limitation of the storage area, from which the data is migrated, as the setting of the input/output limitation of the storage area, to which the data is migrated, when the data stored in one storage area is migrated to another storage area.

18. A virtualizing apparatus for virtualizing, for a host system, each storage area in one or more storage apparatuses, each having one or more storage areas, and thereby providing them as virtual storage areas,
wherein the virtualizing apparatus comprises an input/output limitation controller for consolidating the management of an input/output limitation setting, including a data retention period, for the virtual storage areas by each storage area that constitutes the virtual storage area;
wherein when the data stored in one storage area is migrated to another storage area, the input/output limitation controller manages the input/output limitation of the storage area, from which the data is migrated, as the setting of the input/output limitation of the storage area to which the data is migrated.
